(19) United States
(12) Patent Application Publication
(10) Pub. No.: US 2002/0100504 A1
(43) Pub. Date: Aug. 1, 2002

(54) Noise-reducing liquid distribution system

(75) Inventor: Patrick Mulvaney, Glen Allen, VA (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: HAMILTON BEACH/PROCTOR-SILEX, INC.

(21) Appl. No.: 10/066,255

(22) Filed: Jan. 31, 2002

Related U.S. Application Data
(60) Provisional application No. 60/265,454, filed on Jan. 31, 2001.

(51) Int. Cl. F17D 1/00

(52) U.S. Cl. 137/453

(57) ABSTRACT

A low-noise liquid distribution system for delivering a liquid to a user on demand includes a reservoir and a tank oriented in an inverted position over the reservoir for distributing liquid from the tank to the reservoir. A vent tube has an inlet end that is located outside of the tank and an outlet end that is located in the tank above the liquid level. With this arrangement, when an opening of the tank and the vent tube are at, or immersed below, a level of liquid in the reservoir, the liquid is held within the tank by a combination of vacuum pressure acting on the liquid in the tank and atmospheric pressure acting on the liquid in the reservoir. However, when at least the vent tube is above the level of liquid in the reservoir, the vacuum within the tank is broken as air travels into the tank by way of the vent tube. Accordingly, liquid in the tank is delivered to the reservoir without the formation of air bubbles and their associated noise.

### CROSS-REFERENCE TO RELATED APPLICATIONS

This application claims the benefit of U.S. Provisional Application No. 60/265,454 filed on Jan. 31, 2001 and entitled “Noise-Reducing Water Distribution System”, the disclosure of which is hereby incorporated by reference.

### BACKGROUND OF THE INVENTION

This invention relates to liquid storage tanks, and more particularly to a low-noise or noiseless water distribution system for water tanks or the like.

Water distribution systems can be found in products that are in wide use in offices and homes throughout the world, such as water coolers, humidifiers, automatic pet waterers, and so on. As shown in FIGS. 1 and 2, a prior art water distribution system 10 comprises an inverted water tank 12 and a reservoir 14 positioned below the water tank. A valve 16 or other control mechanism may also be provided for controlling the distribution of water 18 from the reservoir 14.

In operation, the level 20 of water 18 in the reservoir is initially at approximately the same level as the inlet 22 of the water tank 12, as shown in FIG. 2. The combination of atmospheric pressure, as represented by arrows 24, acting on the surface 20 of the water in the reservoir 14 and the vacuum pressure, as represented by arrows 26, acting on a surface 28 of the water in the tank 12 holds the remaining water in the tank 12 and prevents the reservoir from being overfilled. When water is removed from the reservoir 14, such as by opening the valve 16, water is discharged from the reservoir 14 under gravity in a direction as shown by arrow 30 in FIG. 1. As the level 20 of water or liquid in the reservoir descends below the inlet 22, air flows into the water tank 12, as represented by arrow 32 and water bubbles 34, to thereby break the vacuum in the water tank. Consequently, water flows under gravity from the tank 12 to the reservoir 14, as represented by arrow 36. Upon closing the valve 16, the level 20 of the reservoir rises until it reaches the height of the water tank inlet 22. When the vacuum in the water tank 12 is broken, the inrush of air bubbling to through the water can be unacceptably loud, particularly in a quiet room. It would therefore be desirable to provide a water distribution system for water coolers, humidifiers or the like that reduces or eliminates the noise associated with dispensing the water.

### BRIEF SUMMARY OF THE INVENTION

In accordance with one aspect of the invention, a low-noise liquid distribution system for delivering a liquid to a user comprises a reservoir and a tank oriented in an inverted position over the reservoir for delivering liquid in the tank to the reservoir. The reservoir includes a reservoir lower wall and a reservoir continuous side wall that extends upwardly from the reservoir lower wall to thereby form, together with the reservoir lower wall, a reservoir interior that is exposed to atmosphere for holding and distributing a first quantity of liquid to a user. The tank includes a tank upper wall, a tank continuous side wall extending downwardly from the tank upper wall, and a tank lower wall extending from the tank continuous side wall to thereby form, together with the tank upper wall and the tank continuous side wall, a tank interior into which liquid is received. An opening is located in at least one of the tank walls for distributing a second quantity of liquid under gravity to the reservoir. The tank further includes a vent tube with an inlet end that is located outside of the tank and an outlet end that is located in the tank hollow interior. With this arrangement, when the opening and the vent tube are at, or immersed below, a level of liquid in the reservoir, the second quantity of liquid is held within the tank hollow interior by a combination of vacuum pressure acting on the liquid in the tank hollow interior and atmospheric pressure acting on the liquid in the reservoir. However, when at least the vent tube is above the level of liquid in the reservoir, the vacuum within the tank hollow interior is broken and air flows into the tank through the vent tube to thereby deliver the second quantity of liquid to the reservoir without formation of air bubbles and their associated noise.

In accordance with a further aspect of the invention, a liquid holding and distribution tank for a liquid distribution system comprises an upper wall, a continuous side wall extending downwardly from the upper wall, and a lower wall extending from the continuous side wall to thereby form, together with the upper wall and the continuous side wall, a hollow interior into which liquid is received. An opening is located in one of the walls for distributing a quantity of liquid from the tank under gravity to the reservoir. The tank further comprises a vent tube with an inlet end that is located outside of the tank and an outlet end that is located in the hollow interior. With this arrangement, air flow through the vent tube prevents formation of air bubbles in the opening when the quantity of liquid exits the tank through the opening.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a schematic sectional view of a prior art water distribution system with an inverted water tank in the process of filling a reservoir;

FIG. 2 is a schematic sectional view of the prior art water distribution system of FIG. 1 with the reservoir in a filled condition;

FIG. 3 is a schematic sectional view of a liquid distribution system in accordance with an embodiment of the present invention and including a liquid holding tank in the process of filling a reservoir;

FIG. 4 is a schematic sectional view of the liquid distribution system of FIG. 3 with the reservoir in a filled condition;

FIG. 5 is a schematic sectional view of a liquid distribution system in accordance with a further embodiment of the present invention;

FIG. 6 is a schematic sectional view of a liquid distribution system in accordance with an even further embodiment of the present invention;

FIG. 7 is a schematic sectional view of a liquid distribution system in accordance with yet a further embodiment of the present invention;

FIG. 8 is a schematic sectional view of a liquid distribution system in accordance with a further embodiment of the present invention;

FIG. 9 is a schematic sectional view of a lower tank portion that can be used with each of the liquid distribution system embodiments; and

FIG. 10 is a schematic sectional view of a modified lower tank portion that can be used with each of the liquid distribution system embodiments.

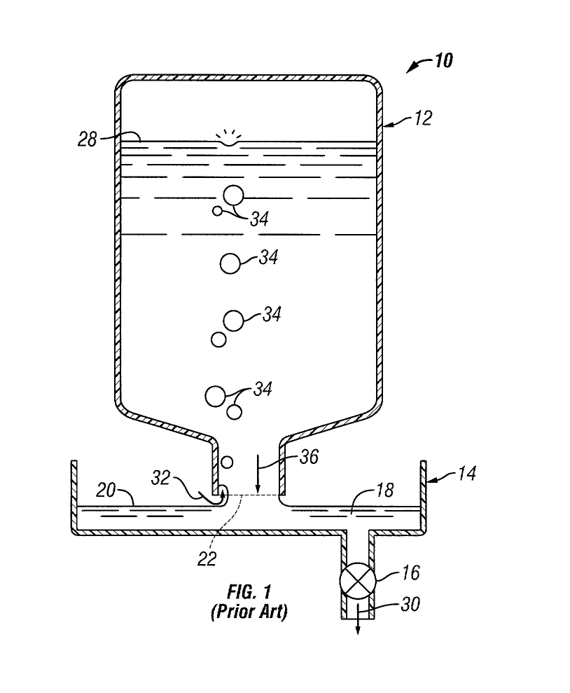

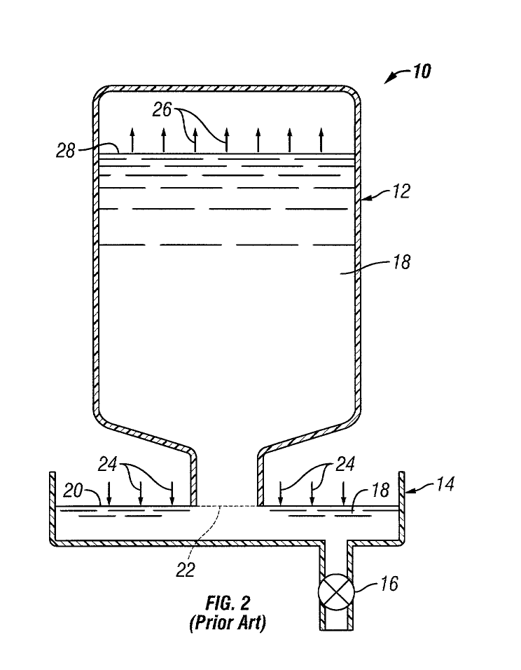

It is noted that the drawings are intended to represent only typical embodiments of the invention and therefore should not be construed as limiting the scope thereof. The invention will now be described in greater detail with reference to the drawings, wherein like parts throughout the drawing figures are represented by like numerals.

### DETAILED DESCRIPTION OF THE INVENTION

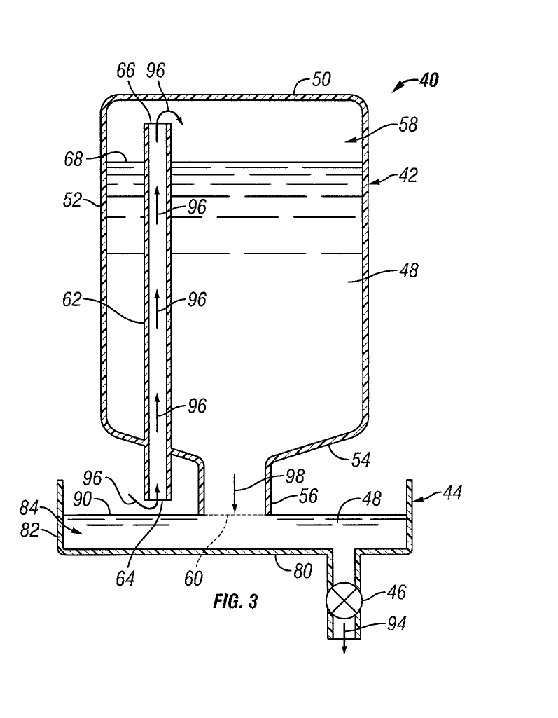

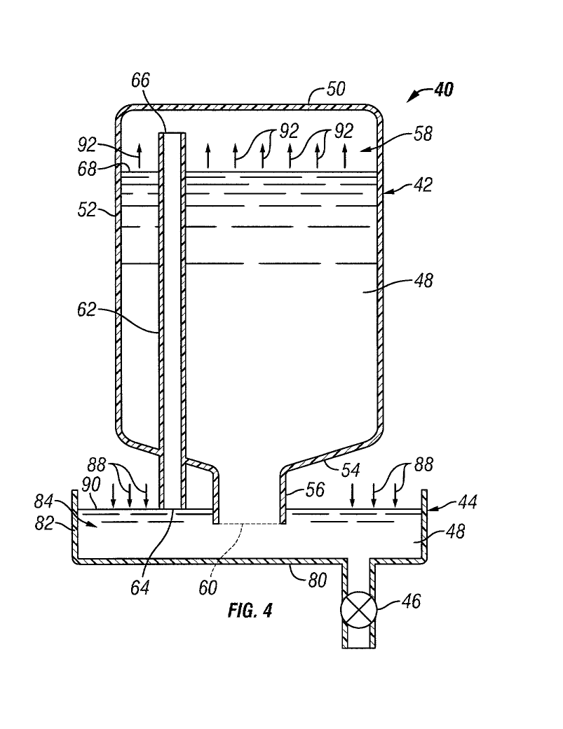

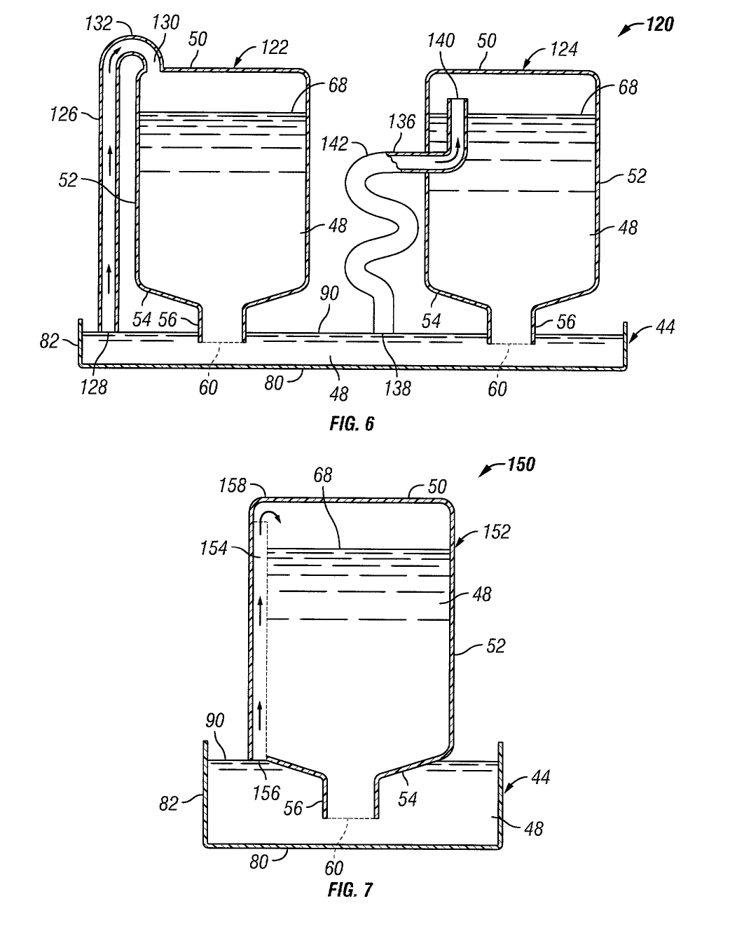

Referring now to the drawings, and to FIGS. 3 and 4 in particular, a liquid distribution system 40 in accordance with the present invention comprises an inverted tank 42 and a reservoir 44 positioned below the tank. A valve 46 or other control mechanism may also be provided for controlling the distribution of liquid 48 from the reservoir 44. Although in some applications the valve 46 is preferable, such as in water coolers, it will be understood that the valve 46 can be eliminated in other applications, such as in automatic waterers for animals where the liquid is lifted or otherwise removed from the reservoir, as shown by way of example in FIGS. 6-10.

The inverted tank 42 preferably has an upper wall 50, a continuous side wall 52 extending downwardly from the upper wall, a lower wall 54 extending generally downwardly and inwardly from the side wall 52, and a neck portion 56 that extends generally downwardly from the lower wall 54, to thereby form a hollow interior 58 into which the liquid 48, such as water, can be received. An opening or mouth 60 (shown in dashed line) is formed at a lower end of the neck portion 56 for transferring liquid into and out of the tank 42. A vent tube 62 preferably extends through the lower wall 54 and into the tank interior 58. The vent tube 62 can be integrally formed with the tank 42, or can be formed separately and sealingly connected to the tank 42 through ultrasonic welding, adhesives, mechanical couplings, or other well-known mounting means. Preferably, an inlet end 64 of the vent tube 62 is higher than the mouth 60 of the inverted tank 42, and an outlet end 66 of the vent tube is normally higher than a level 68 of liquid 48 in the inverted tank.

The reservoir 44 includes a lower wall 80 and a continuous side wall 82 that extends upwardly from the lower wall 80 to form an interior 84 into which the liquid 48 is received and held until the reservoir liquid level drops, such as when the valve 46 is opened in some applications such as water coolers, or when liquid is otherwise removed from the reservoir in other applications such as humidifiers and automatic pet waterers. The interior 84 of the reservoir 44 is preferably open to atmosphere such that atmospheric pressure, as represented by arrows 88, acts on the surface of the liquid 48 in the reservoir.

In operation, the liquid 18 in the reservoir is initially at approximately the same level as the inlet end 64 of the vent tube 62 and preferably at the same or at a higher level than the mouth 60 of the inverted tank 42, as shown in FIG. 4, which effectively seals the interior 58 of the tank 42 from atmosphere. The combination of atmospheric pressure, as represented by arrows 88, acting on the surface 90 of the liquid in the reservoir 44 and the vacuum pressure, as represented by arrows 92, acting on the surface 68 of the liquid in the tank 42 holds the liquid in the tank 42 and prevents the reservoir 44 from being overfilled. In use, the level 90 of liquid 48 in the reservoir 44 drops below the level of the mouth 60, such as when the valve 46 is opened to discharge liquid from the reservoir 44 under gravity in a direction as shown by arrow 94 in FIG. 3, or when the liquid is lifted or otherwise removed from the tank as previously described. As the level 90 of liquid 48 in the reservoir descends below the inlet end 64 of the vent tube 62, air flows into the inverted tank 42, as represented by arrows 96, to thereby break the vacuum in the inverted tank. Since the air entering in and traveling through the vent tube 62 is not in direct contact with the liquid 48 in the inverted tank 42, the generation of air bubbles and their consequent noise is eliminated. Accordingly, liquid flows under gravity from the inverted tank 42 to the reservoir 44, as represented by arrow 98. Since the inlet end 64 of the vent tube 62 is at the same height or higher than the mouth 60 of the tank 42, the liquid in the reservoir will not normally descend below the level of the mouth and the liquid in the tank 42 will flow relatively smoothly into the reservoir 44 without generating air bubbles at the mouth. Upon closing the valve 46, the level 90 of liquid 48 in the reservoir continues to rise until it reaches the height of the inlet end 64 of the vent tube 62 to thereby seal the interior 58 from outside atmosphere. The combination of atmospheric pressure acting on the surface 90 of the liquid in the reservoir 44 and the vacuum pressure acting on the surface 68 of the liquid in the tank 42 again holds the remaining liquid in the tank 42 and prevents the reservoir 44 from being overfilled.

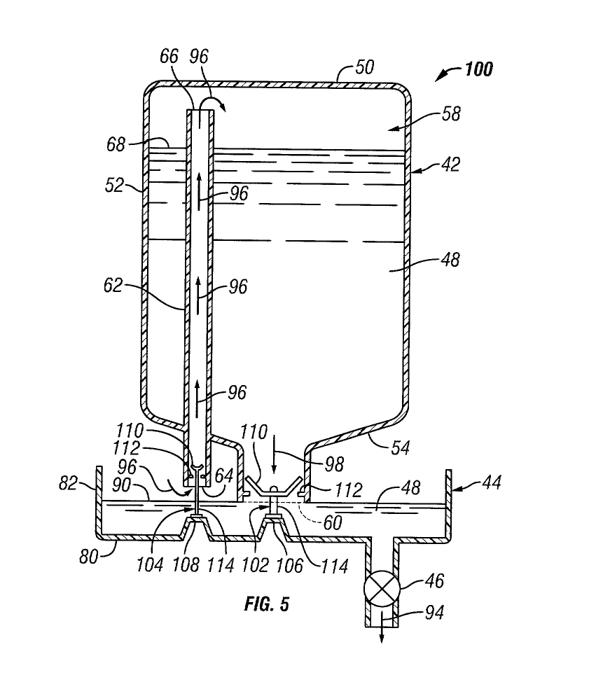

Referring now to FIG. 5, a liquid distribution system 100 in accordance with a further embodiment of the invention is illustrated, wherein like parts in the previous embodiment are represented by like numerals. The liquid distribution system 100 is similar in construction to the liquid distribution system 40, with the exception of a first valve 102 associated with the neck 56 of the tank 42, a second valve 104 associated with the vent tube 62, and protrusions 106 and 108 provided on the reservoir 44 to open the valves 102 and 104, respectively, when the tank 42 is inverted and properly positioned or aligned with respect to the reservoir 44. Each valve 102, 104 is preferably of conventional construction and includes a valve seat 112 that is fixed against movement in the neck 56 and the vent tube 62, and a sealing member 110 that is normally seated against the valve seat 112 under pressure from a spring (not shown) or other bias means. A stem or rod 114 extends from the sealing member 110 for contacting one of the protrusions 106, 108 to thereby unseat the sealing member when the tank 42 is inverted and properly positioned or aligned with respect to the reservoir 44.

With this construction, the normally closed valves seal the liquid within the tank to thereby prevent the ingress of contaminants into the tank and the egress of liquid from the tank during storage, transportation, and inversion of the tank during installation over the reservoir 44. Although the valves 102 and 104 are shown located adjacent the mouth 60 and inlet end 64, respectively, it will be understood that the valves can be located anywhere along the vent tube 62 and the neck 56 or other tank access opening. It will be further understood that the valves 102 and 104 can be replaced with other types of valves, so long as they function to hold liquid in the tank during storage, transportation and inversion of the tank, and allow flow of liquid out of the tank when inverted.

Although the above-described embodiments illustrate the vent tube extending through the bottom wall 54 of the inverted tank, it will be understood that the vent tube can extend through the top wall and/or the side wall, as illustrated in FIG. 6. As shown, a liquid distribution system 120 in accordance with a further embodiment of the invention is illustrated, wherein like parts in the previous embodiments are represented by like numerals. The liquid distribution system 120 includes inverted tanks 122 and 124 associated with a reservoir 44.

The inverted tank 122 has a vent tube 126 with an inlet end 128 that is preferably at the same height as or above the mouth 60 and an outlet end 130 that extends into the top wall 50 of the inverted tank 122 for fluid communication with the interior of the tank 122. The vent tube 126 has a bend 132 between the inlet and outlet ends 128 and 130, respectively. The vent tube 126 can be integrally formed with the tank 122 or can be formed separately and joined to the tank in a well-known manner.

Likewise, the inverted tank 124 has a vent tube 136 with an inlet end 138 that is preferably at the same height as or above the mouth 60 and an outlet end 140 that is positioned in the interior of the tank 124 near the top wall 50. As shown, a middle portion 142 of the vent tube 136 enters the side wall 52 of the inverted tank 124 and may be S-shaped or otherwise formed to dampen or control fluid flow through the vent tube, and thus dampen or control liquid flow from the inverted tank 124 to the reservoir 44. The vent tube 136 can be integrally formed with the tank 124 or can be formed separately and joined to the tank in a well-known manner.

Although in this embodiment two tanks are associated with the reservoir 44, it will be understood that one or more of the tanks 42, 122, and/or 124 can be provided. In addition, it will be understood that plural reservoirs can be associated with a single tank.

Referring now to FIG. 7, a liquid distribution system 150 in accordance with a further embodiment of the invention is illustrated, wherein like parts in the previous embodiments are represented by like numerals. The liquid distribution system 150 includes an inverted tank 152 associated with a reservoir 44.

The inverted tank 152 has a vent tube 154 that is integrally molded with a side wall 52 of the tank. The vent tube 154 has an inlet end 156 that is preferably above the mouth 60, such as at an intersection of the bottom wall 54 and side wall 52, and an outlet end 158 that is adjacent the top wall 50 inside the tank 152.

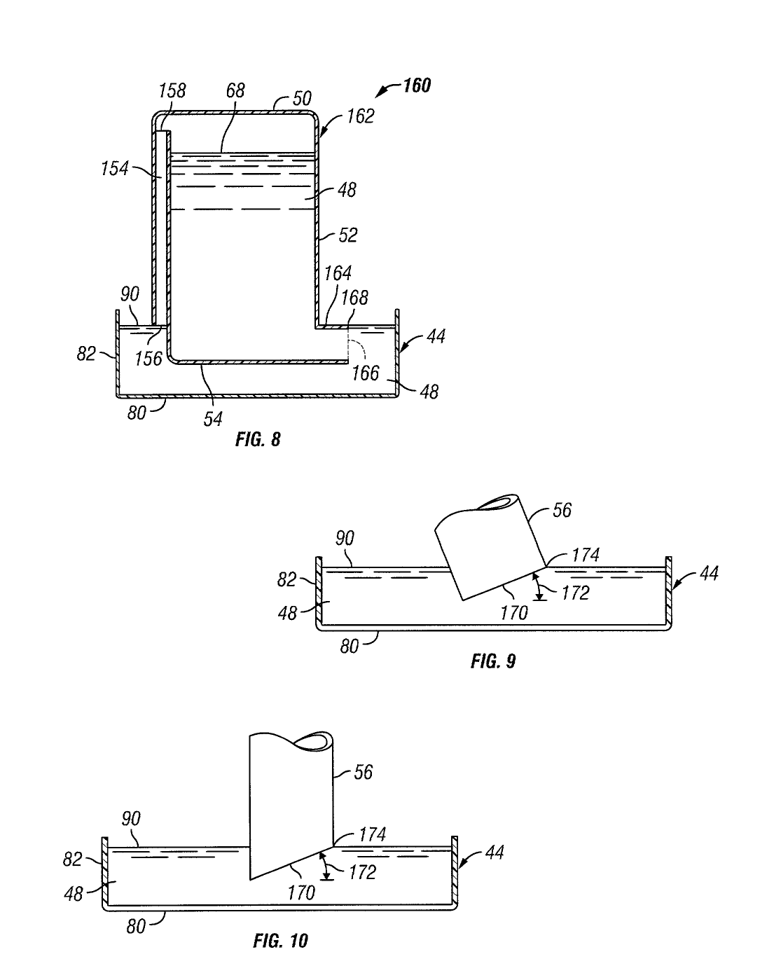

With reference now to FIG. 8, a liquid distribution system 160 in accordance with an even further embodiment of the invention is illustrated, wherein like parts in the previous embodiment are represented by like numerals. The liquid distribution system 160 includes an inverted tank 162 that is similar in construction to the inverted tank 152 previously described, with the exception that a neck portion 164 extends generally horizontally and an opening or mouth 166 extends generally vertically when the tank 152 is mounted in the inverted position. With this construction, the flow of liquid 48 from the tank 162 to the reservoir 44 will tend to be more laminar than in the previous embodiments, resulting in smoother and quieter operation. The inlet end 156 of the vent tube 154 is preferably positioned at or above the highest exit point 168 of the mouth 166 in order to create and break the vacuum effect, as previously described. Although the particular orientation of the mouth 166 has been described for use with the integrally molded vent tube 154, it will be understood that the mouth 60 of the previous embodiments may be similarly constructed.

In accordance with a further embodiment of the invention, and with reference to FIGS. 9 and 10, each of the previous embodiments can be further modified by orienting an opening or mouth 170 of the inverted tank at an angle 172 between horizontal and vertical, such as by tilting the tank, as shown in FIG. 9, or by forming the mouth at an angle 172, as shown in FIG. 10. The inlet end of the vent tube (not shown in FIGS. 9 and 10) is preferably positioned at or above the highest exit point 174 of the mouth 170 in order to create and break the vacuum effect, as previously described. With this arrangement, the flow of liquid from the tank to the reservoir will tend to be more laminar, resulting in smoother and quieter operation.

It will be understood that various terms of orientation and/or position as may be used throughout the specification, such as upper, lower, side, upward, downward, and their respective derivatives and equivalent terms are intended to denote relative, rather than absolute orientations and/or positions.

It will be appreciated by those skilled in the art that changes could be made to the embodiments described above without departing from the broad inventive concept thereof. It should be appreciated that the tank of the present invention may find applicability with a wide variety of liquid distribution systems, including, but not limited to, water cooler bottles, humidifier water tanks, water bottles for automatic waterers used for pets or other animals, and so on. It will be further appreciated that the tank can be formed in a wide variety of sizes, shapes, configurations such as multiple tank openings located in one or more of the tank walls, and materials to accommodate a wide variety of applications. It will be understood, therefore, that this invention is not limited to the particular embodiments and applications disclosed, but it is intended to cover modifications within the spirit and scope of the present invention as defined by the appended claims.

I/we claim:

1. A low-noise liquid distribution system for delivering a liquid to a user, the liquid distribution system comprising:
a reservoir comprising:
a reservoir lower wall; and
a reservoir continuous side wall extending upwardly from the reservoir lower wall to thereby form, together with the reservoir lower wall, a reservoir interior that is exposed to atmosphere for holding and distributing a first quantity of liquid to a user;
a tank oriented in an inverted position over the reservoir, the tank comprising:
a tank upper wall;
a tank continuous side wall extending downwardly from the tank upper wall;
a tank lower wall extending from the tank continuous side wall to thereby form, together with the tank upper wall and the tank continuous side wall, a tank interior into which liquid is received;
an opening located in at least one of the tank walls for distributing a second quantity of liquid under gravity from the tank to the reservoir; and
a vent tube having an inlet end that is located outside of the tank and an outlet end that is located in the tank interior;
whereby when the opening and the vent tube are at, or immersed below, a level of liquid in the reservoir, liquid is held in the tank by a combination of vacuum pressure acting on the liquid in the tank and atmospheric pressure acting on the liquid in the reservoir, and when at least the vent tube is above the level of liquid in the reservoir, the vacuum within the tank is broken and air travels into the tank interior by way of the vent tube, to thereby deliver the second quantity of liquid from the tank to the reservoir without forming air bubbles and noise associated therewith.

2. A liquid distribution system according to claim 1, wherein the inlet end of the vent tube is positioned above the opening.

3. A liquid distribution system according to claim 2, and further comprising a neck portion extending from one of the tank lower wall and the tank continuous side wall, with the opening comprising a mouth at a distal end of the neck portion.

4. A liquid distribution system according to claim 3, wherein the outlet end of the vent tube is located adjacent the upper wall of the tank above a level of liquid in the tank.

5. A liquid distribution system according to claim 2, wherein the outlet end of the vent tube is located adjacent the tank upper wall above a level of liquid in the tank.

6. A liquid distribution system according to claim 1, wherein the outlet end of the vent tube is located adjacent the tank upper wall above a level of liquid in the tank.

7. A liquid distribution system according to claim 1, and further comprising a neck portion extending from one of the tank lower wall and the tank continuous side wall, with the opening comprising a mouth at a distal end of the neck portion.

8. A liquid distribution system according to claim 1, and further comprising a first valve positioned in one of the vent tube and the opening for preventing unwanted escape of liquid out of the tank at least during inversion of the tank from an upright position toward the inverted position.

9. A liquid distribution system according to claim 8, and further comprising a second valve positioned in the other of the vent tube and the opening for preventing unwanted escape of liquid out of the tank at least during inversion of the tank from the upright position toward the inverted position.

10. A liquid distribution system according to claim 9, wherein the reservoir comprises first and second protrusions for contacting and opening the first and second valves, respectively, when the tank is inverted and properly positioned over the reservoir.

11. A liquid distribution system according to claim 8, wherein the reservoir comprises a first protrusion for contacting and opening the first valve when the tank is inverted and properly positioned over the reservoir.

12. A liquid holding and distribution tank for a liquid distribution system having a reservoir for holding and delivering liquid from the tank, the tank comprising:
an upper wall;
a continuous side wall extending downwardly from the upper wall;
a lower wall extending from the continuous side wall to thereby form, together with the upper wall and the continuous side wall, an interior into which liquid is received;
an opening located in at least one of the walls for distributing a quantity of liquid from the tank under gravity to the reservoir; and
a vent tube having an inlet end that is located outside of the tank and an outlet end that is located in the tank interior;
wherein air flow through the vent tube prevents formation of air bubbles in the opening when the quantity of liquid exits the tank through the opening.

13. A liquid holding and distribution tank according to claim 12, wherein the inlet end of the vent tube is positioned above the opening.

14. A liquid holding and distribution tank according to claim 13, and further comprising a neck portion extending from one of the tank lower wall and the tank continuous side wall, with the opening comprising a mouth at a distal end of the neck portion.

15. A liquid holding and distribution tank according to claim 14, wherein the outlet end of the vent tube is located adjacent the upper wall above a level of liquid in the tank.

16. A liquid holding and distribution tank according to claim 13, wherein the outlet end of the vent tube is located adjacent the upper wall above a level of liquid in the tank.

17. A liquid holding and distribution tank according to claim 12, wherein the outlet end of the vent tube is located adjacent the upper wall above a level of liquid in the tank.

18. A liquid holding and distribution tank according to claim 12, and further comprising a neck portion extending from one of the tank lower wall and the tank continuous side wall, with the opening comprising a mouth at a distal end of the neck portion.

19. A liquid holding and distribution tank according to claim 12, and further comprising a first valve positioned in one of the vent tube and the opening for preventing unwanted escape of liquid out of the tank at least during inversion of the tank from an upright position toward an inverted position.

20. A liquid distribution system according to claim 19, and further comprising a second valve positioned in the other of the vent tube and the opening for preventing unwanted escape of liquid out of the tank at least during inversion of the tank from the upright position toward the inverted position.
